(19) United States
(12) Patent Application Publication
(10) Pub. No.: US 2026/0289351 A1
(43) Pub. Date: Sep. 24, 2026

(54) METHOD OF MODEL TRAINING, ELECTRONIC DEVICE AND STORAGE MEDIUM

(71) Applicant: Beijing Baidu Netcom Science Technology Co., Ltd., Beijing (CN)

(72) Inventors: Dianhai YU, Beijing (CN); Haifeng WANG, Beijing (CN); Guoxia WANG, Beijing (CN); Jinle ZENG, Beijing (CN); Tian WU, Beijing (CN)

(21) Appl. No.: 19/685,933

(22) Filed: May 22, 2026

(30) Foreign Application Priority Data
Jul. 21, 2025 (CN) 202511007324.2

(51) Int. Cl. G06N 5/04; G06N 20/00

(52) U.S. Cl. CPC G06N 5/04; G06N 20/00

(57) ABSTRACT

Provided is a method of model training, an electronic device and a storage medium, relating to the field of data processing technologies, and in particular, to the technical fields of artificial intelligence, big data, large models and deep learning. The method includes: obtaining target sample data corresponding to N branches required in a current training period of distributed training; performing T update operations on network parameters of a preset model deployed on the N training nodes for the distributed training based on T data blocks corresponding to the branches to obtain first full parameter sets corresponding to the branches; performing model parameter fusion on the first full parameter sets to obtain a fused full parameter set; and updating the network parameters of the preset model deployed on the training nodes based on the fused full parameter set and proceeding to the next training period to obtain a target model.

### CROSS-REFERENCE TO RELATED APPLICATIONS

The present application claims priority to Chinese Patent Application No. CN202511007324.2, filed with the China National Intellectual Property Administration on Jul. 21, 2025, the disclosure of which is hereby incorporated herein by reference in its entirety.

### TECHNICAL FIELD

The present disclosure relates to the field of data processing technologies, and in particular, to the technical fields of artificial intelligence, big data, large models and deep learning.

### BACKGROUND

With the increase in the complexity of problems, the depth and scale of large models are constantly improving, and distributed training has emerged as the times require and become a mainstream method for training large models. However, traditional distributed training methods usually require frequent gradient aggregation between computing nodes, which results in large communication overhead and becomes a bottleneck restricting the efficiency of distributed training.

### SUMMARY

The present disclosure provides a method and apparatus of model training, a device and a storage medium.

In a first aspect, the present disclosure provides a method of model training, including:
obtaining target sample data corresponding to N branches required in a current training period of distributed training, wherein the target sample data corresponding to the branches includes T different data blocks required for T training iterations; N and T are integers greater than 1;
performing T update operations on network parameters of a preset model deployed on the N training nodes for the distributed training based on the T data blocks corresponding to the branches, to obtain first full parameter sets corresponding to the branches, wherein the first full parameter set represents parameter values of the network parameters in the preset model after T update operations;
performing model parameter fusion on the first full parameter sets corresponding to the branches to obtain a fused full parameter set; and
updating the network parameters of the preset model deployed on the training nodes based on the fused full parameter set, and proceeding to the next training period to obtain a target model.

In a second aspect, the present disclosure provides a method of model inference, including:
determining a target inference task;
inputting the target inference task to a target model to obtain a target inference result, wherein the target model is obtained by training according to the method as set forth above.

In a third aspect, the present disclosure provides an apparatus of model training, including:
an obtaining unit, configured to obtain target sample data corresponding to N branches required in a current training period of distributed training, wherein the target sample data corresponding to the branches includes T different data blocks required for T training iterations; N and T are integers greater than 1; and
a training unit, configured to perform T update operations on network parameters of a preset model deployed on the N training nodes for the distributed training based on the T data blocks corresponding to the branches, to obtain first full parameter sets corresponding to the branches, wherein the first full parameter set represents parameter values of network parameters in the preset model after T update operations; perform model parameter fusion on the first full parameter sets corresponding to the branches to obtain a fused full parameter set; and update the network parameters of the preset model deployed on the training nodes based on the fused full parameter set, and proceed to the next training period to obtain a target model.

In a fourth aspect, the present disclosure provides an apparatus of model inference, including:
an input unit, configured to obtain a target inference task; and
an inference unit, configured to input the target inference task to a target model to obtain a target inference result, wherein the target model is obtained by training according to the method as set forth above.

In a fifth aspect, the present disclosure provides an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

In a sixth aspect, the present disclosure provides a non-transitory computer-readable storage medium storing a computer instruction thereon, and the computer instruction is used to cause a computer to execute the method of any embodiment of the present disclosure.

In a seventh aspect, the present disclosure provides a computer program product including a computer program which, when executed by a processor, implements the method of any embodiment of the present disclosure.

Therefore, in one training period, the scheme of the present disclosure can first perform multiple independent trainings on the preset model deployed on the training nodes used for distributed training by using the T data blocks corresponding to the branches, to obtain the first full parameter sets corresponding to the branches. Then, the scheme of the disclosure can perform the parameter fusion on the first full parameter sets corresponding to the branches, and finally, synchronize the fused parameter set to the preset model deployed on the training nodes. This process eliminates frequent gradient aggregation across different training nodes, achieves decoupling of fine-grained gradient aggregation and the overall training process, significantly reduces the communication overhead between the training nodes, and further reduces the dependence and occupation of the distributed training on bandwidth resources. In such a manner, the bottleneck of distributed training efficiency can be effectively broken through, and the training efficiency of the distributed training can be greatly improved.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are included to provide a better understanding of the present solution and are not to be construed as limiting the present disclosure. In the drawings:

FIG. 1 is a schematic flowchart of a method of model training according to an embodiment of the present disclosure;

FIG. 2(a) and 2(b) are illustrative diagrams of the method of model training in a specific example according to the embodiment of the present disclosure;

FIG. 3 is a schematic diagram illustrating the deployment effect between a plurality of serially connected sub-nodes and a plurality of sub-models included in a first training node according to an embodiment of the present disclosure;

FIG. 4 is an illustrative diagram of tensor parallel processing by a plurality of training units included in the second sub-node in the first training node according to an embodiment of the present disclosure;

FIG. 5 is another schematic flowchart of a method of model training according to an embodiment of the present disclosure;

FIG. 6(a) is an illustrative diagram of pipelined processing using three sub-nodes included in the first training node according to an embodiment of the present disclosure;

FIG. 6(b) is an illustrative diagram of tensor parallel processing by the sub-nodes included in the first training node according to an embodiment of the disclosure;

FIG. 7 is a schematic diagram illustrating a comparison of training effects between the scheme of the present disclosure and the scheme of the prior art;

FIG. 8 is a schematic flowchart of a method of model inference according to an embodiment of the present disclosure;

FIG. 9 is schematic block diagram of an apparatus of model training according to an embodiment of the present disclosure;

FIG. 10 is schematic block diagram of an apparatus of model inference according to an embodiment of the present disclosure; and

FIG. 11 is a block diagram of an electronic device for implementing the method of model training or the method of model inference according to the embodiment of the present disclosure.

### DETAILED DESCRIPTION

Exemplary embodiments of the present disclosure are described below with reference to the accompanying drawings, in which various details of embodiments of the present disclosure are included to assist understanding, and which are to be considered as merely exemplary. It should therefore be understood that those skilled in the art may make various changes and modifications to the described embodiments without departing from the scope of the present disclosure. For the sake of clarity and conciseness, well-known functions and structures are not described in detail herein.

The term “and/or” as used herein merely denotes an association relationship for describing associated objects, meaning three possible relationships. For example, A and/or B means three cases: A exists alone, both A and B exist simultaneously, and B exists alone. The term “at least one” as used herein refers to any one of a plurality of items, or any combination of at least two of them. For example, including at least one of A, B or C means including any one or more elements selected from the group consisting of A, B or C. The terms “first” and “second” as used herein are used to refer to and distinguish a plurality of similar technical terms, and do not intend to limit the order of the terms or mean that only two such terms are involved. For example, “first feature” and “second feature” refer to two types of features or two features, where there may be one or more first features and one or more second features.

Furthermore, in the following detailed description, numerous specific details are set forth in order to provide a better understanding of the present disclosure. It will be understood by those skilled in the art that the present disclosure may be practiced without some of these specific details. In some instances, the methods, means, elements and circuits that are well known to those skilled in the art have not been described in detail so as not to obscure the subject matter of the present disclosure.

The related technologies of the embodiments of the present disclosure are described hereinafter, and the following related technologies, as optional solutions, can be arbitrarily combined with the technical solutions of the embodiments of the present disclosure, all of which fall within the protection scope of the embodiments of the present disclosure.

The following explanation is provided with respect to the content involved in the distributed training of large models:
(1) Data Parallel (DP), or Distributed Data Parallel (DDP): A training data set is split into a plurality of data subsets, which are distributed to a plurality of computing devices (also referred to as worker nodes), wherein each computing device maintains a complete model replica and performs its respective forward and backward propagation. After computing a local gradient, each computing node performs synchronization and averaging across all computing devices, for example, by an all-reduce operation, so as to ensure that all model replicas update their parameters in the same manner and remain consistent.
(2) Model Parallel (MP): A large-scale model is split into a plurality of components, which are distributed to different computing devices, thereby avoiding the problem that a single computing device fails to accommodate an ultra-large model due to memory insufficiency.

Further, the Model Parallel may involve Tensor Parallel and Pipeline Parallel, as follows:
Tensor Parallel (TP): A single tensor (e.g., a weight matrix) is sliced along specific dimensions across multiple computing devices, with each computing device only computing a portion of the tensor. The Tensor Parallel offers the advantage of further scaling the model beyond the memory limits of a single computing device. However, this parallel approach incurs significant communication overhead. For example, during forward and backward propagation, frequent collective communication operations need to be performed between different shard devices (such as all-reduce, all-gather, and reduce-scatter), for the exchange of intermediate activation values and gradients of tensor shards.
Pipeline Parallel (PP): Based on data parallel, for each branch, the model can be sequentially divided into multiple stages, which are then distributed to different computing devices for execution. In other words, each stage is executed on a separate computing device, and an activation value is transferred between adjacent stages when a boundary is encountered during execution. The Pipeline Parallel reduces inter-device communication compared to the Tensor Parallel. However, due to micro-batching and sequential dependencies, “pipeline bubble” (i.e., idle time) is introduced, which arises from additional communication caused by periodic refreshing and an increased number of pipeline stages.

With the increasing complexity of problems, the depth and scale of the large-scale model are constantly expanding, and distributed training has emerged as a result, becoming the mainstream approach for training the large-scale model. However, traditional distributed training methods typically require frequent gradient aggregation between computing nodes, which results in substantial communication overhead and has become a bottleneck that restricts the training efficiency of distributed training.

To address the issue of substantial communication overhead in traditional distributed training, the present disclosure proposes a method of model training, and in particular, a distributed training method based on asynchronous parameter fusion for a large-scale model. Specifically, under the framework of data parallel, this method enables a preset model deployed on a training node in data parallel to undergo independent training on data of a batch size; in other words, each replica is independently trained on a larger data batch (e.g., a global batch size (gbs)). Furthermore, after the number of training iterations for a training node reaches a preset threshold, an explicit fusion is performed on a parameter set obtained from independent training on the training node (i.e., the parameter set of network parameters of the model) to generate a fused parameter set, and then this fused parameter set is synchronized to initial models deployed on all training nodes. This process fundamentally changes the synchronization mode in data parallel. In contrast to the need for frequent gradient aggregation among different training nodes in data parallel, the present disclosure eliminates the frequent reduce-scatter operations associated with gradient aggregation in data parallel, and achieves periodic parameter fusion and parameter synchronization among different training nodes. This effectively ensures the parameter consistency of the model at a coarse granularity and in the meanwhile, avoids the inherent communication conflicts associated with gradient aggregation, thereby enhancing the training efficiency of distributed training.

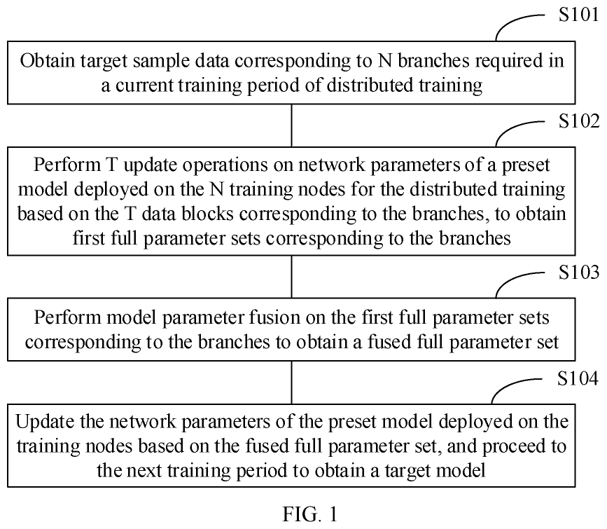

Specifically, FIG. 1 is a schematic flowchart of a method of model training according to an embodiment of the present disclosure. This method may be optionally applied to an electronic device, such as a personal computer, a server and a server cluster.

Further, the method includes at least part of the following content. As shown in FIG. 1, the method includes:

Step S101: obtaining target sample data corresponding to N branches (N is an integer greater than 1) required in a current training period of distributed training.

Here, the target sample data corresponding to the branches includes T different data blocks required for T (T is an integer greater than 1) training iterations.

Step S102: performing T update operations on network parameters of a preset model deployed on the N training nodes for the distributed training based on the T data blocks corresponding to the branches, to obtain first full parameter sets corresponding to the branches.

Here, the first full parameter set represents parameter values of the network parameters in the preset model after T update operations.

Here, it should be noted that each branch corresponds to a training node; in other words, in one example, N branches correspond one-to-one with N training nodes. Further, a complete preset model is deployed on the training nodes of the branches.

Further, for the target sample data corresponding to the branches, one of the T data blocks included in the target sample data corresponds to one training iteration, and in short, one training iteration needs to consume one data block.

For example, in distributed training, for a branch, one of the T data blocks corresponding to the branch is used to perform one update operation on the network parameters of the initial model deployed on the training node corresponding to the branch among the N training nodes, thereby completing one global training (also referred to as one training iteration). This process is repeated, and such T global trainings can be completed by using the T data blocks. Further, after the T-th global training of the preset model deployed on the training node is completed, the set of network parameters of the preset model following the T-th global training can be used as the first full parameter sets corresponding to the branches. For the N branches, a respective first full parameter set corresponding to a branch can be obtained.

Here, the update operation on the network parameters of the preset model deployed on the training node may be specifically understood as updating at least a portion of the network parameters of the preset model deployed on the training node, thus completing one training iteration.

Step S103: performing model parameter fusion on the first full parameter sets corresponding to the branches to obtain a fused full parameter set.

Step S104: updating the network parameters of the preset model deployed on the training nodes based on the fused full parameter set, and proceeding to the next training period to obtain a target model.

It should be noted that after the network parameters of the preset model deployed on the training node are updated by using the obtained fused full parameter set, one training period of distributed training (e.g., the current training period) is completed. Furthermore, if a preset training requirement is not met, the next training period may be entered, and the above-mentioned training process (i.e., Steps S101 to S104) may be repeated.

For example, in one example, after a preset model with updated parameters in the current training period is obtained, the preset model with updated parameters in the current training period may be verified to obtain a verification result corresponding to the current training period. When the verification result does not meet the preset training requirement, the next training period is entered to update the network parameters of the preset model with updated parameters by using the above-mentioned training process.

That is to say, in the current training period of distributed training, when the training node performs one training iteration on the preset model deployed thereon using the data block, the scheme of the disclosure may employ the calculated gradients to update the network parameters of the preset model, without the gradient aggregation across different training nodes. In such a manner, the communication overhead that may be generated during the distributed training can be effectively reduced.

Therefore, in one training period, the scheme of the present disclosure can first perform multiple independent trainings on the preset model deployed on the training nodes used for distributed training by using the T data blocks corresponding to the branches, to obtain the first full parameter sets corresponding to the branches. Then, the scheme of the disclosure can perform the parameter fusion on the first full parameter sets corresponding to the branches, and finally, synchronize the fused parameter set to the preset model deployed on the training nodes. This process eliminates frequent gradient aggregation across different training nodes, achieves decoupling of fine-grained gradient aggregation and the overall training process, significantly reduces the communication overhead between the training nodes, and further reduces the dependence and occupation of the distributed training on bandwidth resources. In such a manner, the bottleneck of distributed training efficiency can be effectively broken through, and the training efficiency of the distributed training can be greatly improved.

Furthermore, since the scheme of the disclosure can perform periodic parameter fusion and parameter synchronization among different training nodes instead of gradient aggregation. In other words, by adjusting the synchronization mode in data parallel from gradient aggregation-based synchronization to parameter fusion-based synchronization, the scheme of the disclosure effectively addresses the problem of excessive communication overhead caused by gradient aggregation in data parallel. Compared with the distributed training scheme that requires frequent gradient aggregation, the scheme of the disclosure adopts a coarser-grained synchronization mechanism, which effectively ensures the parameter consistency of the preset model at a coarser granularity. This fundamentally resolves the problem of communication resource competition and conflicts caused by frequent gradient aggregation, thereby significantly improving communication efficiency and overall training throughput, while enhancing the fault tolerance of the system to heterogeneity.

Moreover, since the scheme of the disclosure reduces the communication overhead caused by gradient aggregation in the distributed training, the reduced communication overhead can facilitate the system to scale more data parallel devices. Thus, compared with the distributed training scheme that requires frequent gradient aggregation, the scheme of the disclosure also has better flexibility and scalability.

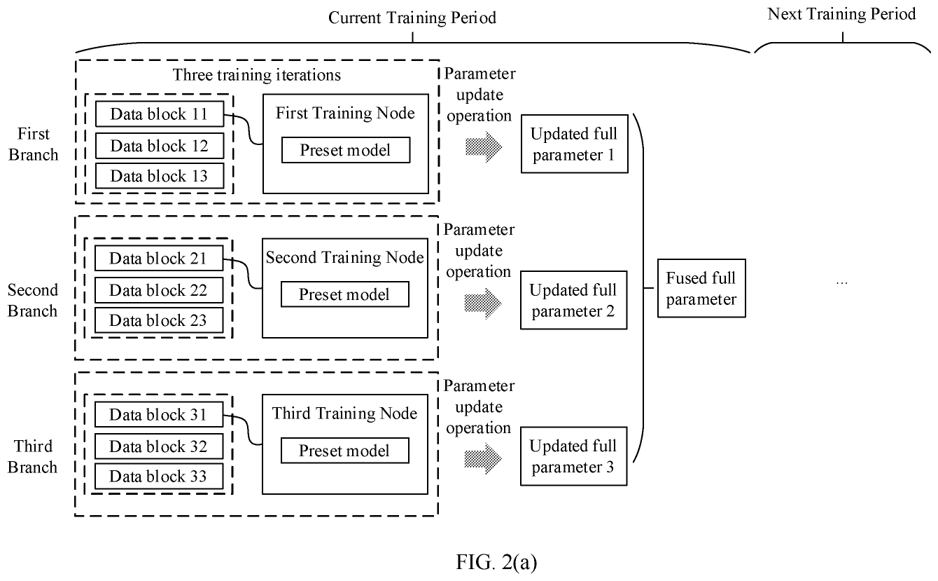

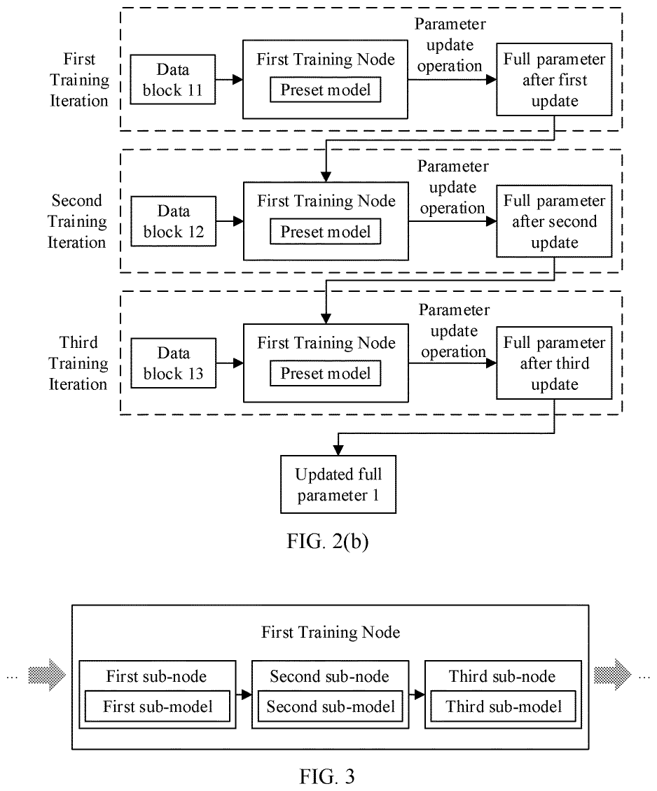

For example, as shown in FIG. 2(a), the number N of branches required for the current training period of the distributed training is 3, for example, which may be denoted as the first branch, the second branch, and the third branch, respectively. The 3 training nodes used for the distributed training may be denoted as the first training node, the second training node, and the third training node, respectively. Furthermore, the number T of data blocks included in the target sample data corresponding to the branches is also 3. In this case, the 3 data blocks included in the target sample data corresponding to the first branch may be denoted as data block 11, data block 12, and data block 13, respectively; the 3 data blocks included in the target sample data corresponding to the second branch may be denoted as data block 21, data block 22, and data block 23, respectively; and the 3 data blocks included in the target sample data corresponding to the third branch may be denoted as data block 31, data block 32, and data block 33, respectively.

Furthermore, the 3 data blocks corresponding to the branch are used to perform 3 update operations (i.e., 3 training iterations) on the preset model deployed on the training node used for the distributed training, respectively. For example, as shown in FIG. 2(b), for the first training node, the data block 11 is used to perform the first training iteration on the preset model deployed on the first training node, thereby completing a parameter update and obtaining a full parameter set after the first update. Next, the data block 12 is used to perform the second training iteration on the preset model after the first parameter update, thereby completing another parameter update and obtaining a full parameter set after the second update. Furthermore, the data block 13 is used to perform the third training iteration on the preset model after the second parameter update, thereby completing the last parameter update in the current period and obtaining a full parameter set of the first training node after the last update operation, which is the full parameter set after the third update. At this point, the full parameter set after the third update is the updated full parameter 1 obtained in the current training period. In such a manner, the full parameter sets obtained after the last update operation corresponding to the branches are obtained, which may be denoted, for example, as updated full parameter 1, updated full parameter 2, and updated full parameter 3, respectively. Subsequently, the model parameter fusion is performed on the obtained three updated full parameter sets to obtain a fused full parameter set. Then, the obtained fused full parameter set is used to update the network parameters of the preset models deployed on the training nodes, thereby completing the training task of the current training period.

Here, upon completion of the training task in the current training period, the next training period can be entered, and the training process in the next training period may follow the above-described process.

It should be noted that the “model parameter fusion” in the scheme of the present disclosure refers to a parameter fusion implemented through collective communication operations (e.g., all-reduce operations) between different training nodes. Compared with the traditional parameter aggregation method based on a Parameter Server (PS), the fusion in the scheme of the present disclosure is a more easily decentralized parameter consistency method, which delivers better scalability and effectively avoids the single-point bottleneck problem that a centralized Parameter Server may encounter.

Here, in a specific example, the “model parameter fusion” in the scheme of the present disclosure can be regarded as an application of the Weight Average (WA) technique, which can maintain the consistency of training nodes in data parallel within a highly coupled distributed training environment. Moreover, the “model parameter fusion” can not only yield a better optimal solution, but also periodically align divergent model states (i.e., the states where the model fails to learn stably), thereby enabling the efficient execution of the training process.

Further, in an example, the preset model may refer to a to-be-trained model with initialized network parameters, or a model with updated network parameters from the previous training period. The scheme of the present disclosure imposes no specific limitation in this regard.

Further, the “preset model” referred to in the scheme of the present disclosure may specifically denote a large-scale neural network model, such as a Large Language Model (LLM), also called a large model, or a Mixture of Experts (MoE) model. The scheme of the present disclosure imposes no limitation on the specific model. Here, for the large-scale neural network model, the scheme of the present disclosure enables efficient large-scale distributed training in a resource-constrained environment, thereby providing robust support for improving training efficiency.

Further, in a specific example, the number T of training iterations corresponding to different training periods may, or may not, be the same. It should be noted that in a practical application, the number of training iterations for the next training period can be determined based on the training effect of the preset model obtained upon completion of the current training period. In other words, the number of iterations within a single training period can be flexibly set, which effectively reduces the resource and time costs required for distributed training and thus significantly improves the training efficiency of distributed training.

Further, in a specific example, the number N of branches corresponding to different training periods may, or may not, be the same. For example, the number of branches can be determined based on a requirement of actual applicable scenario or a data volume of the training dataset. In other words, the scheme of the present disclosure enables dynamic adjustment of the number of branches for different training periods, which makes it possible to regulate the utilization of overall computing resources while ensuring the training efficiency and effect within training periods, thereby effectively avoiding the waste of computing resources.

Further, in a specific example, the training node contains M serially connected sub-nodes (where M is an integer greater than 1), and different sub-models of the preset model are deployed on different sub-nodes, thereby enabling pipelined model processing by using the M serially connected sub-nodes.

For example, taking the first training node in the distributed training shown in FIG. 2(a) as an example, the first training node contains three serially connected sub-nodes, as illustrated in FIG. 3, which may be denoted as the first sub-node, the second sub-node and the third sub-node, respectively. The preset model can be split into three serially processable components based on a processing sequence or a dependency relationship between network layers, which may be denoted as the first sub-model, the second sub-model and the third sub-model, respectively. Further, the first sub-model can be deployed on the first sub-node, the second sub-model on the second sub-node, and the third sub-model on the third sub-node. In this regard, in a single training iteration process, an input to the first training node can be directly used as an input to the first sub-model, an output of the first sub-model as an input to the second sub-model, and an output of the second sub-model as an input to the third sub-model. In such a manner, the three serially connected sub-nodes can achieve the pipelined model processing.

That is to say, in the scheme of the present disclosure, the data can be transmitted between two adjacent sub-nodes, which improves processing efficiency while effectively reducing communication overhead between devices.

Therefore, the scheme of the present disclosure leverages M serially connected sub-nodes for pipelined model processing, effectively alleviating the memory load of a single node and further improving the processing efficiency of the preset model deployed on the training nodes. Especially for the large-scale model with a large number of parameters, the pipelined parallel scheme of the present disclosure can effectively boost an overall training speed and prediction accuracy of the model, thereby laying a foundation for enhancing the performance and generalization ability of the model.

Further, in a specific example, the sub-node may further include a plurality of training units. In an example, a training unit may specifically be a hardware device such as a GPU or other model accelerators, whereby facilitating tensor parallel processing by using the plurality of training units included in the sub-node.

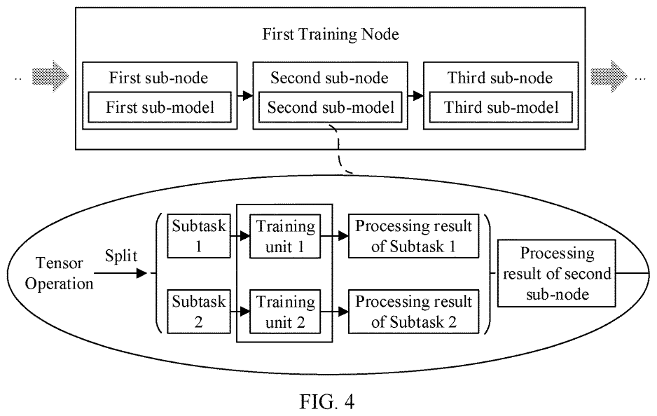

For example, taking the second sub-node in the first training node shown in FIG. 3 as an example, as illustrated in FIG. 4, the tensor operation required for the second sub-model (e.g., matrix multiplication or attention processing) can be split based on the number of training units contained in the second sub-node to generate a plurality of subtasks. For instance, assuming that the second sub-node includes training unit 1 and training unit 2, the tensor operation can be split into two subtasks (i.e., subtask 1 and subtask 2), which are then assigned to training unit 1 and training unit 2, respectively, for parallel processing the two subtasks by using training unit 1 and training unit 2. Finally, processing results of the subtasks are aggregated via communication between the training units (such as an all-reduce operation) to obtain a processing result of the second sub-node. In such a manner, the tensor parallel further boosts the efficiency of data processing.

Therefore, the scheme of the present disclosure enables tensor parallel via the plurality of training units configured for a sub-model when the sub-model processes data. This allows the training unit to process only a portion of the tensors, thereby significantly improving the computational efficiency of the sub-model and laying a foundation for enhancing the overall performance and generalization ability of the model. In addition, the scheme of the present disclosure also supports data processing for a model with more parameters, thereby delivering stronger adaptability.

Further, in an example, the number of training units included in different sub-nodes may, or may not be the same. For instance, the number of training units for a sub-node can be determined based on a requirement of an actual scenario or a data processing volume of the sub-model. This enhances the data processing capability of the sub-node, thereby providing robust support for improving the subsequent training efficiency of the model.

In a specific example, to ensure the robustness of the parameter update in the training node, the preset model deployed on the training node in the scheme of the present disclosure can be independently trained on a significantly larger data batch. This improves the training effect while effectively eliminating frequent gradient aggregation across the training nodes and boosting training efficiency.

For instance, in an example, a data volume of the data block is determined based on the preset global batch size (gbs) in the distributed training. For instance, in an example, the data volume of the data block corresponds to the preset global batch size.

That is to say, the scheme of the present disclosure enables the preset model deployed on the training node to be independently trained on data at a volume of the global batch size. The data at the volume of the global batch size represents a broader data distribution, which allows the effective integration of sample information from the global dataset when calculating local gradients during the training iteration. This makes the calculated local gradients statistically more robust, thereby effectively ensuring that the direction of local optimization aligns with the global optimization direction, further enhancing the robustness of local optimization, preventing divergence caused by noise gradients, and providing a strong support for maintaining optimization quality during subsequent asynchronous updates. In addition, more stable and more effective training can be achieved even without gradient aggregation across training nodes.

Moreover, the training iterations performed by the data block at the volume of global batch size can maintain high gradient quality, and thus the parameter results obtained from gradient updates in the training iterations are more reliable. This allows the scheme of the present disclosure to be implemented in a more tightly controlled cluster environment.

Alternatively, in another example, a data volume corresponding to a training unit (i.e., a data volume for a training unit configured in a sub-node) is determined based on a preset local batch size (lbs) in the distributed training. For instance, in an example, the data volume for the training unit in the sub-node corresponds to the preset global batch size.

That is to say, the training unit included in the sub-node can process data at the volume of the local batch size, which can significantly increase the training speed. In addition, the setting of the local batch size can avoid gradient estimation issues caused by an overlarge data batch, thereby improving processing efficiency as well as the utilization of hardware resources.

Still alternatively, in another example, the data volume of the data block is determined based on the preset global batch size in the distributed training; and the data volume corresponding to the training unit is determined based on the preset local batch size in the distributed training.

Here, in an example, the data volume of the data block is equal to a sum of data volumes processable by the training units on the sub-node.

For example, in an example, for a training node, the data volume allocated to the training node is at the volume of gbs, and the data volume allocated to a training unit in a sub-node of the training node is at the volume of lbs, where the data volume allocated to the training node=the data volume allocated to a training unit×the number of training units in the training node.

Therefore, the scheme of the present disclosure enables setting the different data batch size according to different model processing levels. For example, the data volume processable by the training node can be set at the volume of global batch size, and/or the data volume corresponding to the training unit included in the sub-node can be set at the volume of local batch size. This allows for the acquisition of broader sample information during subsequent model training while improving resource utilization and reducing actual training time, thereby enhancing the robustness of parameter optimization within the training node.

Further, in a specific example, the preset model may be split into a plurality of components in the following manner to deploy the components on respective sub-nodes within a training node. For instance, in an example, before performing the update operation, the method further includes:
determining network structure characteristics of the preset model; and
splitting, based on the network structure characteristics of the preset model, a plurality of network layers included in the preset model into M sub-models.

Here, the M sub-models have a preset series connection relationship, and are deployed on the M serially connected sub-nodes, wherein different sub-models are deployed on respective sub-nodes, and the input-output relationship (or referred to as a connection relationship) between the deployed sub-models satisfies the preset series connection relationship.

For example, taking the first training node shown in FIG. 3 as an example, according to the network structure characteristics of the preset model such as the dependency relationships between network layers in the preset model, the network layers with dependency relationships among the plurality of network layers included in the preset model are grouped into the same part, thereby splitting the model into three components, i.e., three sub-models, which may be denoted as the first sub-model, the second sub-model, and the third sub-model, respectively. One of the sub-models includes at least a network layer, and the preset series connection relationship of the three sub-models is “first sub-model→second sub-model→third sub-model”; in other words, an output of the first sub-model serves as an input of the second sub-model, and an output of the second sub-model serves as an input of the third sub-model. At this point, the three sub-models obtained by splitting may be deployed on the three serially connected sub-nodes. For instance, the first sub-model is deployed on the first sub-node, the second sub-model on the second sub-node, and the third sub-model on the third sub-node. In such a manner, the input-output relationship between the deployed sub-models satisfies the preset series connection relationship, thereby providing robust support for pipeline processing.

Here, in practical applications, in the process of splitting the preset model based on the dependency relationships between the network layers, not only the dependency relationships between the network layers but also the parameter amounts of the network layer may be considered. This ensures that the parameter amounts corresponding to different sub-models in the split result are relatively balanced, thereby further improving the processing efficiency of the sub-node. For ultra-large models with massive parameter amounts, this effectively alleviates the resource burden when a single model performs data processing while also improving the efficiency of the model in processing data.

Therefore, the scheme of the present disclosure splits the preset model into M sub-models based on the network structure characteristics of the preset model, and then deploys the M sub-models on the M serially connected sub-nodes. This significantly reduces the resource requirement for a single sub-node, enabling the model to be easily deployed on the resource-constrained device while also balancing training efficiency. In addition, the scheme of the present disclosure also helps enhance the robustness and maintainability of the model.

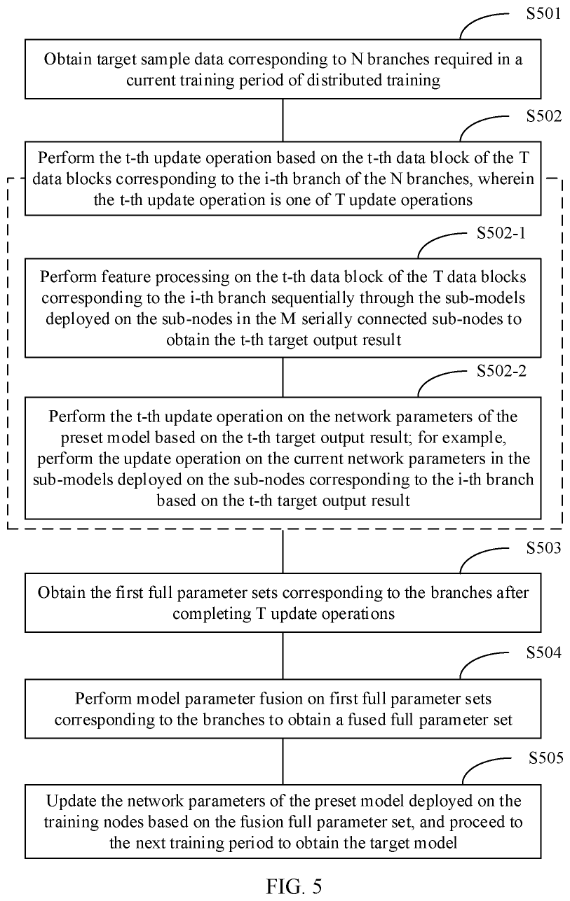

FIG. 5 is another schematic flowchart of a method of model training according to an embodiment of the present disclosure. The method may be applied to an electronic device, such as a personal computer, a server, a server cluster, or the like. It will be appreciated that the relevant descriptions of the methods shown in FIGS. 1 to 4 are also applicable to the present example and will not be repeated herein.

Further, the method includes at least part of the following contents. Specifically, as shown in FIG. 5, the method includes:

Step S501: obtaining target sample data corresponding to N branches (N is an integer greater than 1) required in a current training period of distributed training.

Here, the target sample data corresponding to the branches includes T (T is an integer greater than 1) different data blocks required for T training iterations.

Step S502: performing the t-th (t is an integer greater than or equal to 1 and less than or equal to T) update operation based on the t-th data block of the T data blocks corresponding to the i-th branch of the N branches.

Here, the t-th update operation is one of T update operations.

Further, the t-th update operation includes the following steps:

Step S502-1: performing feature processing on the t-th data block of the T data blocks corresponding to the i-th branch sequentially through the sub-models deployed on the sub-nodes in the M serially connected sub-nodes to obtain the t-th target output result.

Here, the network parameters in the sub-models deployed on the sub-nodes for the t-th update operation are obtained based on a result of the previous update operation.

It will be appreciated that the previous update operation may be the (t−1)-th update operation, or the last update operation in the previous training period.

For example, in an example, when the value of t is not 1, the network parameters in the sub-models deployed on the sub-nodes for the t-th updating operation are obtained based on the (t−1)-th updating operation, that is, the network parameters after the (t−1)-th update operation; or, in another example, when the value of t is 1, the network parameters in the sub-models deployed on the sub-nodes for the t-th update operation are initialized network parameters in the sub-models deployed on the sub-nodes, or are network parameters in a fused full parameter set obtained after the previous training period.

Step S502-2: performing the t-th update operation on the network parameters of the preset model based on the t-th target output result. For example, the update operation is performed on the current network parameters in the sub-models deployed on the sub-nodes corresponding to the i-th branch based on the t-th target output result.

It should be noted that, after the above steps are utilized, the T update operations for the i-th branch are completed. Further, the network parameters of the preset model obtained after the T-th update operation may be used as the first full parameter set corresponding to the i-th branch.

Further, for the N branches, first full parameter sets corresponding to the branches may be obtained.

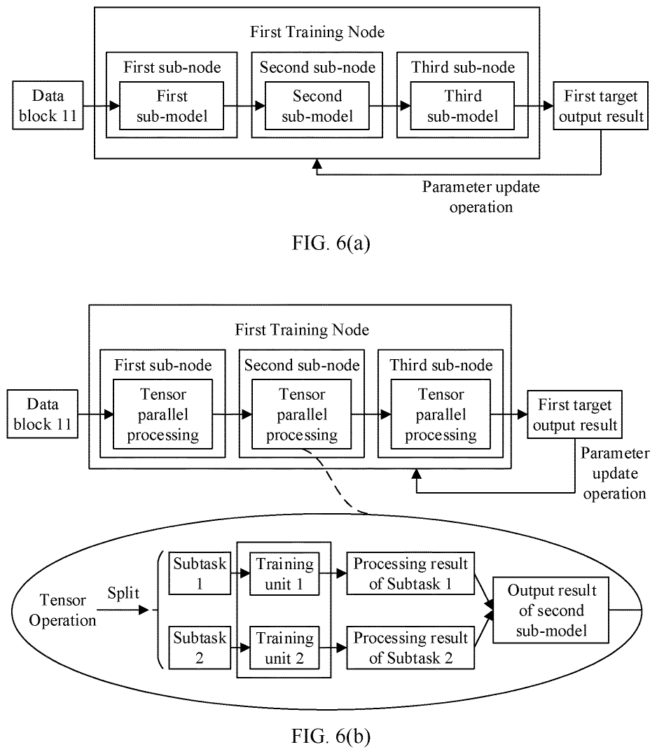

For example, taking the first training node shown in FIG. 2(b) and FIG. 3 as an example, as shown in FIG. 6(a), the data block 11 among the three data blocks corresponding to the first branch is input to the first sub-node in the first training node, to perform feature processing on the data block 11 by using the first sub-model deployed on the first sub-node and obtain an output result of the first sub-node; the output result of the first sub-node is input to the second sub-node, to perform feature processing on the output result of the first sub-node by using the second sub-model deployed on the second sub-node and obtain an output result of the second sub-node; further, the output result of the second sub-node is input to the third sub-node, to perform feature processing on the output result of the second sub-node by using the third sub-model deployed on the third sub-node and obtain an output result of the third sub-node; at this time, the output result of the third sub-node is the first target output result corresponding to the first branch, and the first target output result is then used to perform the first update operation on the network parameters of the preset model deployed on the first training node.

Further, after the first update operation is completed, the second update operation may be performed by using other data blocks (for example, the data block 12) among the three data blocks corresponding to the first branch, and specific steps may refer to the foregoing process. Thus, by using the three data blocks, an updated full parameter 1 corresponding to the first branch can be obtained. Further, for the three branches, updated full parameter sets corresponding to different branches can be obtained.

Step S503: obtaining the first full parameter sets corresponding to the branches after completing T update operations.

Here, the first full parameter set represents parameter values of the network parameters in the preset model after T update operations.

Step S504: performing model parameter fusion on first full parameter sets corresponding to the branches to obtain a fused full parameter set.

Step S505: updating the network parameters of the preset model deployed on the training nodes based on the fusion full parameter set, and proceeding to the next training period to obtain the target model.

Therefore, the scheme of the present disclosure can use the M serially connected sub-nodes in the i-th training node to perform pipelined processing on the t-th data block, thereby implementing pipeline parallel processing under a data parallel framework. While effectively alleviating the resource burden of data processing performed by a single model, the scheme makes model training more robust, improves the reliability of the training result, enhances data processing efficiency, and thus improves the effect and efficiency of distributed training.

It should be noted that in conventional technologies of distributed training, after a calculation stage (such as forward calculation and backward propagation) is completed, a training node corresponding to the DP immediately performs collective communication operations (such as all-gather operations of parameters and reduce-scatter operations of gradients). Obviously, frequent collective communication operations impose a high requirement on bandwidth resources, and the requirement on bandwidth resources increases as the scale expands. Moreover, conventional pipeline parallel also requires frequent and fine-grained Peer-to-Peer (P2P) communication to transfer intermediate activation values and gradients. However, when the two types of communication are simultaneously active, problems such as contention conflicts of communication resources and synchronization barriers are likely to occur.

The scheme of the present disclosure eliminates frequent gradient aggregation among the training nodes in data parallel, thereby avoiding contention conflicts of communication resources between DP and PP caused by frequent communication, significantly improving communication efficiency and overall training throughput, and enabling large-scale model training to be performed in a high-performance cluster with both high performance and high efficiency.

Further, in a specific example, the t-th target output result may be obtained in the following manner. Specifically, the operation of performing feature processing on the t-th data block of the T data blocks corresponding to the i-th branch sequentially through the sub-models deployed on the sub-nodes in the M serially connected sub-nodes to obtain the t-th target output result may specifically include: performing a tensor parallel processing flow based on the t-th data block of the T data blocks corresponding to the i-th branch by using the plurality of training units included in the m-th (m is an integer greater than or equal to 1 and less than or equal to M) sub-node of the M sub-nodes to obtain an output result of the m-th sub-node; here, relevant details of tensor parallel processing in the sub-node may refer to the example shown in FIG. 4 and are omitted herein.

Further, the t-th target output result is obtained based on the output result of the m-th sub-node.

Here, it should be noted that the input of the m-th sub-node may be the t-th data block, or may also be the output result of the previous sub-node of the m-th sub-node, or may also be the output result of the previous training node of the training node corresponding to the m-th sub-node. It is to be appreciated that the input of the m-th sub-node is related to the specific location of the m-th sub-node in the distributed training system, and the solution of the present disclosure imposes no specific limitation thereon.

Further, in a specific example, the t-th target output result may be obtained in the following manner. Specifically, obtaining the t-th target output result based on the output result of the m-th sub-node may specifically include:
using the output result of the m-th sub-node as the t-th target output result in the case that the m-th sub-node is the last sub-node in the current training node; or,
inputting the output result of the m-th sub-node to the (m+1)-th sub-node until the output result of the last sub-node in the current training node is obtained in the case that the m-th sub-node is not the last sub-node in the current training node.

Here, the output result of the last sub-node in the current training node is the t-th target output result.

For example, continuing to take the first training node in FIG. 6(a) as an example, as shown in FIG. 6(b), in the case that the tensor parallel processing is performed by using a plurality of training units included in the second sub-node and an output result of the second sub-node is obtained, since the second sub-node is not the last sub-node, the output result of the second sub-node may be used as an input of the third sub-node to perform the tensor parallel processing by using a plurality of training units included in the third sub-node, so as to obtain an output result of the third sub-node, where the output result of the third sub-node is the first target output result.

Therefore, the scheme of the present disclosure provides a refined scheme for obtaining the t-th target output result. Specifically, the tensor parallel processing flow can be executed by using the plurality of training units included in the sub-node, such that the training unit only needs to process a portion of the tensor, thereby significantly improving the computation efficiency of the sub-model. Moreover, the refined scheme is simple, practical and easy to implement, and efficiently completes the training iterations of the preset model deployed on the training node, thereby laying a foundation for improving the performance and generalization capability of the model.

### Applicable Examples of the Disclosure

### Application Example I

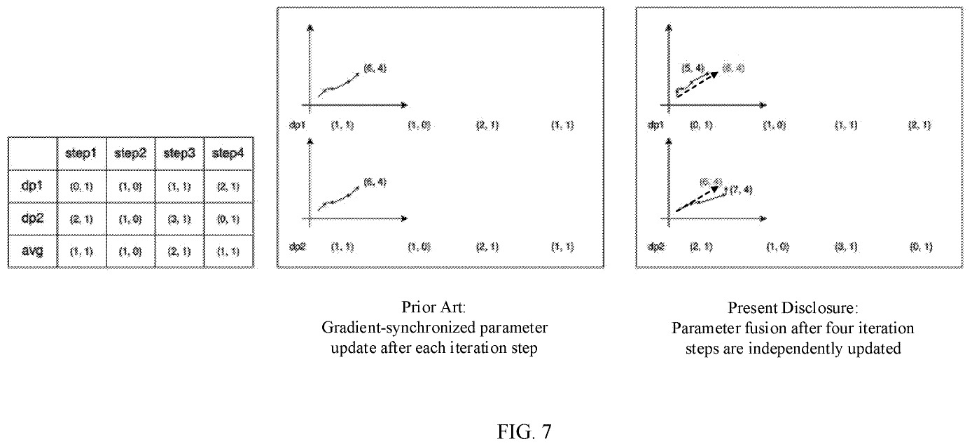

By way of example with a two-dimensional plane, FIG. 7 is a schematic diagram illustrating a comparison of training effects between the scheme of the present disclosure and the scheme of the prior art after four iteration steps. The conventional gradient-synchronized distributed training method synchronizes the gradients among different the DPs at each step, and then updates parameters. The parameter fusion training method in the present disclosure completely eliminates gradient synchronization among the DPs, performs four updates using independent gradients, and then executes online parameter fusion after four learning iterations. As shown in FIG. 7, the convergence effects of the two methods are substantially the same after four learning iterations.

### Application Example II

On a GPU cluster, a MoE model with a parameter size of 200 bits is trained by using a combination strategy of three parallel techniques including DP, TP and PP. Here, the model can be trained by using the conventional distributed training method and the scheme of the present disclosure, respectively.

Here, it is assumed that the dimension of data parallel (denoted as dp_degree) is 8, the dimension of tensor parallel (denoted as tp_degree) is 2, and the dimension of pipeline parallel (denoted as pp_degree) is 4. That is to say, the DP replica among the 8 data parallel replicas (corresponding to data required by the 8 branches) spans 2 TP devices and 4 PP stages.

### (1) Traditional Distributed Training Method

In the conventional distributed training method, each of the 8 DP replicas processes a micro-batch level of data. After backward propagation of each micro-batch is completed, a gradient reduce-scatter operation is immediately triggered. Meanwhile, the PP stage transmits or receives activation values and gradients via Peer-to-Peer (P2P) communication.

However, frequent and collective gradient reduce-scatter operations among the DPs introduce significant communication overhead and cause contention conflicts for bandwidth resources with continuous P2P communication in the PP, which further leads to network congestion, communication stalls and pipeline bubbles. This results in a large proportion (e.g., 30%-50%) of GPUs being idle due to communication waiting, thereby reducing overall throughput.

### (2) Distributed Training Method of the Disclosure

Step 1: Initialization stage. In this stage, parameter values of network parameters of the MoE model corresponding to each of the 8 DP replicas (corresponding to the target sample data as described above) are initialized such that the parameter values of the network parameters of the MoE model corresponding to each DP replica are identical.

Step 2: Independent training stage. In this stage, the MoE model corresponding to each DP replica is independently trained on data with a global batch size (gbs) such that one training iteration is completed by the MoE model corresponding to each DP replica. The above operations are repeated until the number of training iterations reaches K (e.g., 100).

During K training iterations, no gradient aggregation is performed among the DP replicas, thereby ensuring that continuous P2P communication in the PP is free from resource contention and can proceed smoothly.

Step 3: Parameter fusion stage. After the MoE model corresponding to each DP replica has performed K training iterations, a collective communication operation, i.e., a parameter fusion operation, is initiated among the DP replicas to fuse the updated full parameters corresponding to each DP replica, so as to obtain a fused full parameter set. For example, a parameter all-gather operation is performed on each DP replica to obtain a full parameter set corresponding to each DP replica. Then, a weighted average (or other fusion strategy) is performed on the full parameter sets corresponding to the DP replicas to obtain a new full parameter set. The new full parameter set is then synchronized to the MoE model corresponding to each DP replica in a broadcast manner to update the network parameters of the MoE model corresponding to each DP replica.

Thus, compared with the conventional distributed training method, the scheme of the present disclosure has the following advantages:

Firstly, Conflict Elimination. The scheme of the present disclosure effectively eliminates frequent gradient aggregation operations among the DP replicas, thereby avoiding resource conflicts between the DP replicas and the PP, and thus ensuring that P2P communication in the PP can proceed smoothly. Moreover, the scheme of the present disclosure also improves throughput, enabling GPUs to remain computationally busy for a longer period of time, thereby reducing idle time caused by communication waiting.

Secondly, Shortening Actual Training Time. The scheme of the present disclosure eliminates frequent gradient aggregation operations among the DP replicas, improves the distributed training efficiency of the model, and significantly reduces the overall training time.

Thirdly, Robustness. Since the scheme of the present disclosure only requires coarser-grained parameter fusion among the DPs and conducts interval synchronization, it is more robust to transient network problems or delayed devices within each DP group.

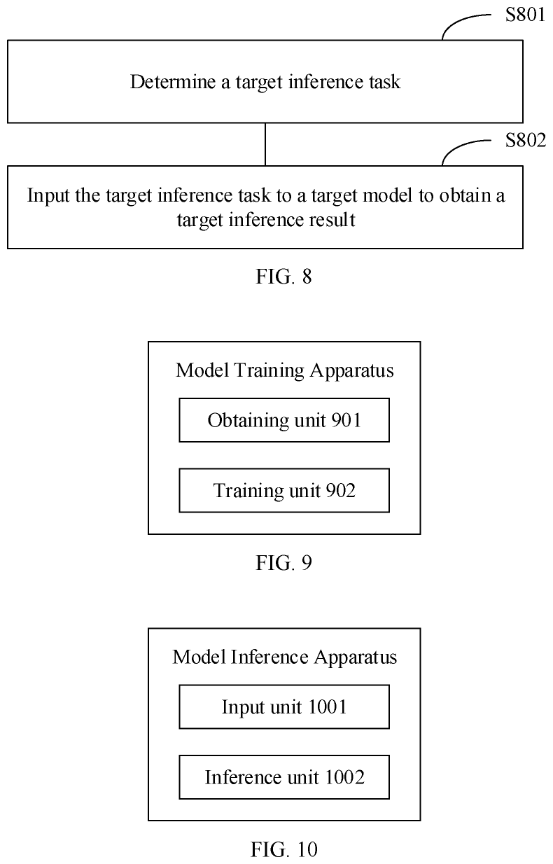

FIG. 8 is a schematic flowchart of a method of model inference according to an embodiment of the present disclosure. The method is optionally applied to an electronic device, such as a personal computer, a server, a server cluster and the like.

Further, the method includes at least part of the following contents. As shown in FIG. 8, the method includes:

Step S801: determining a target inference task;

Step S802: inputting the target inference task to a target model to obtain a target inference result.

Here, the target model may be obtained by training based on any one of the above methods of model training.

Therefore, the scheme of the present disclosure can utilize the target model after distributed training to perform inference on the target inference task, and accurately obtain a real and reliable inference result. In such a manner, the accuracy and stability of the inference system are effectively improved, thereby enhancing user experience.

The scheme of the present disclosure further provides an apparatus of model training, as shown in FIG. 9, including:
an obtaining unit 901, configured to obtain target sample data corresponding to N branches required in a current training period of distributed training, wherein the target sample data corresponding to the branches includes T different data blocks required for T training iterations; N and T are integers greater than 1; and
a training unit 902, configured to perform T update operations on network parameters of a preset model deployed on the N training nodes for the distributed training based on the T data blocks corresponding to the branches, to obtain first full parameter sets corresponding to the branches, wherein the first full parameter set represents parameter values of network parameters in the preset model after T update operations; perform model parameter fusion on the first full parameter sets corresponding to the branches to obtain a fused full parameter set; and update the network parameters of the preset model deployed on the training nodes based on the fused full parameter set, and proceed to the next training period to obtain a target model.

In a specific example of the scheme of the present disclosure, the number T of training iterations corresponding to different training periods may, or may not, be the same.

In a specific example of the scheme of the present disclosure, the number N of branches corresponding to different training periods may, or may not, be the same.

In a specific example of the scheme of the present disclosure, the training node contains M serially connected sub-nodes, and different sub-models of the preset model are deployed on different sub-nodes, thereby enabling pipelined model processing by using the M serially connected sub-nodes; M is an integer greater than 1.

In a specific example of the scheme of the present disclosure, the sub-node includes a plurality of training units, to perform tensor parallel processing by using the plurality of training units included in the sub-node.

In a specific example of the scheme of the present disclosure, the number of training units included in different sub-nodes is, or is not, the same.

In a specific example of the scheme of the present disclosure, a data volume of the data block is determined based on a preset global batch size (gbs) in the distributed training; and/or,
a data volume corresponding to a training unit is determined based on a preset local batch size (lbs) in the distributed training.

In a specific example of the scheme of the present disclosure, the data volume of the data block is equal to a sum of data volumes processable by the training units on the sub-node.

In a specific example of the scheme of the present disclosure, the apparatus further includes a preprocessing unit configured to:
determine network structure characteristics of the preset model; and
split, based on the network structure characteristics of the preset model, a plurality of network layers included in the preset model into M sub-models, wherein the M sub-models have a preset series connection relationship, and are deployed on the M serially connected sub-nodes to satisfy the preset series connection relationship.

In a specific example of the scheme of the present disclosure, the training unit is specifically configured to:
perform the t-th update operation based on the t-th data block of the T data blocks corresponding to the i-th branch, wherein the t-th update operation is one of T update operations, and t is an integer greater than or equal to 1 and less than or equal to T;
wherein the t-th update operation includes the following steps:
performing feature processing on the t-th data block of the T data blocks corresponding to the i-th branch sequentially through the sub-models deployed on the sub-nodes in the M serially connected sub-nodes to obtain the t-th target output result, wherein the network parameters in the sub-models deployed on the sub-nodes for the t-th update operation are obtained based on the previous update operation; and
performing the t-th update operation on the network parameters of the preset model based on the t-th target output result.

In a specific example of the scheme of the present disclosure, the training unit is specifically configured to:
perform a tensor parallel processing flow based on the t-th data block of the T data blocks corresponding to the i-th branch by using the plurality of training units included in the m-th sub-node of the M sub-nodes to obtain an output result of the m-th sub-node; and
obtain the t-th target output result based on the output result of the m-th sub-node.

In a specific example of the scheme of the present disclosure, the training unit is specifically configured to:
use the output result of the m-th sub-node as the t-th target output result in the case that the m-th sub-node is the last sub-node in the current training node; or,
input the output result of the m-th sub-node to the (m+1)-th sub-node to obtain the output result of the last sub-node in the current training node in the case that the m-th sub-node is not the last sub-node in the current training node, wherein the output result of the last sub-node in the current training node is the t-th target output result.

For a detailed description of the specific functions and examples of each unit in the apparatus according to embodiments of the present disclosure, reference may be made to the corresponding steps in the foregoing method embodiments, which will not be repeated herein.

The scheme of the present disclosure further provides an apparatus of model inference, as shown in FIG. 10, including:
an input unit 1001, configured to obtain a target inference task; and
an inference unit 1002, configured to input the target inference task to a target model to obtain a target inference result, wherein the target model is obtained by training based on the training method.

For a detailed description of the specific functions and examples of each unit in the apparatus according to embodiments of the present disclosure, reference may be made to the corresponding steps in the foregoing method embodiments, which will not be repeated herein.

In the technical scheme of the disclosure, the collection, storage, and use of users'personal information are conducted in compliance with all applicable laws and regulations and are consistent with public order and good morals.

According to embodiments of the present disclosure, the present disclosure also provides an electronic device, a readable storage medium and a computer program product.

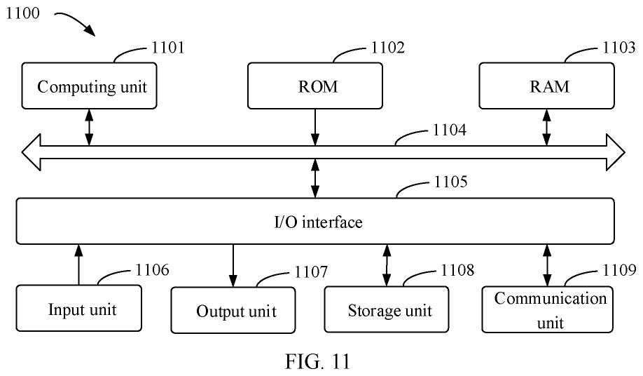

FIG. 11 shows a schematic block diagram of an exemplary electronic device 1100 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar electronic devices. The components shown herein, their connections and relationships, and their functions are merely examples, and are not intended to limit the implementation of the present disclosure described and/or required herein.

As shown in FIG. 11, the electronic device 1100 includes a computing unit 1101 that may perform various appropriate actions and processes according to a computer program stored in a Read-Only Memory (ROM) 1102 or a computer program loaded from a storage unit 1108 into a Random Access Memory (RAM) 1103. Various programs and data required for an operation of device 1100 may also be stored in the RAM 1103. The computing unit 1101, the ROM 1102 and the RAM 1103 are connected to each other through a bus 1104. The input/output (I/O) interface 1105 is also connected to the bus 1104.

A plurality of components in the electronic device 1100 are connected to the I/O interface 1105, and include an input unit 1106 such as a keyboard, a mouse, or the like; an output unit 1107 such as various types of displays, speakers, or the like; the storage unit 1108 such as a magnetic disk, an optical disk, or the like; and a communication unit 1109 such as a network card, a modem, a wireless communication transceiver, or the like. The communication unit 1109 allows the electronic device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1101 performs various methods and processing described above, such as the above the method of model training. For example, in some implementations, the above method of model training may be implemented as a computer software program tangibly contained in a computer-readable medium, such as the storage unit 1108. In some implementations, a part or all of the computer program may be loaded and/or installed on the device 1100 via the ROM 1102 and/or the communication unit 1109. When the computer program is loaded into RAM 1103 and executed by the computing unit 1101, one or more steps of the method of model training described above may be performed. Alternatively, in other implementations, the computing unit 1101 may be configured to perform the above method of model training by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method of model training, comprising:
obtaining target sample data corresponding to N branches required in a current training period of distributed training, wherein the target sample data corresponding to the branches includes T different data blocks required for T training iterations; N and T are integers greater than 1;
performing T update operations on network parameters of a preset model deployed on the N training nodes for the distributed training based on the T data blocks corresponding to the branches, to obtain first full parameter sets corresponding to the branches, wherein the first full parameter set represents parameter values of the network parameters in the preset model after T update operations;
performing model parameter fusion on the first full parameter sets corresponding to the branches to obtain a fused full parameter set; and
updating the network parameters of the preset model deployed on the training nodes based on the fused full parameter set, and proceeding to the next training period to obtain a target model.

2. The method of claim 1, wherein a training node comprises M serially connected sub-nodes, and different sub-models of the preset model are deployed on different sub-nodes, so as to perform pipelined model processing by using the M serially connected sub-nodes; M is an integer greater than 1.

3. The method of claim 2, wherein a sub-node comprises a plurality of training units, so as to perform tensor parallel processing by using the plurality of training units included in the sub-node.

4. The method of claim 3, wherein a number of training units included in different sub-nodes is same or different.

5. The method of claim 3, wherein a data volume of a data block is determined based on a preset global batch size in distributed training.

6. The method of claim 3, wherein a data volume corresponding to a training unit is determined based on a preset local batch size in distributed training.

7. The method of claim 3, wherein the data volume of the data block is a sum of data volumes processable by the training units on the sub-node.

8. The method of claim 2, further comprising:
determining network structure characteristics of the preset model; and
splitting, based on the network structure characteristics of the preset model, a plurality of network layers included in the preset model into M sub-models, wherein the M sub-models have a preset series connection relationship, and are deployed on the M serially connected sub-nodes to meet the preset series connection relationship.

9. The method of claim 3, wherein the performing of the T update operations on the network parameters of the preset model deployed on the N training nodes for the distributed training based on the T data blocks corresponding to the branches, comprises:
performing the t-th update operation based on the t-th data block of the T data blocks corresponding to the i-th branch, wherein the t-th update operation is one of T update operations, and t is an integer greater than or equal to 1 and less than or equal to T;
wherein the t-th update operation comprises the following steps:
performing feature processing on the t-th data block of the T data blocks corresponding to the i-th branch sequentially through the sub-models deployed on the sub-nodes in the M serially connected sub-nodes to obtain the t-th target output result, wherein the network parameters in the sub-models deployed on the sub-nodes for the t-th update operation are obtained based on the previous update operation; and
performing the t-th update operation on the network parameters of the preset model based on the t-th target output result.

10. The method of claim 9, wherein the performing of the feature processing on the t-th data block of the T data blocks corresponding to the i-th branch sequentially through the sub-models deployed on the sub-nodes in the M serially connected sub-nodes to obtain the t-th target output result, comprises:
performing a tensor parallel processing flow based on the t-th data block of the T data blocks corresponding to the i-th branch by using the plurality of training units included in the m-th sub-node of the M sub-nodes to obtain an output result of the m-th sub-node; and
obtaining the t-th target output result based on the output result of the m-th sub-node.

11. The method of claim 10, wherein the obtaining of the t-th target output result based on the output result of the m-th sub-node, comprises:
using the output result of the m-th sub-node as the t-th target output result in the case that the m-th sub-node is the last sub-node in the current training node.

12. The method of claim 10, wherein the obtaining of the t-th target output result based on the output result of the m-th sub-node, comprises:
inputting the output result of the m-th sub-node to the (m+1)-th sub-node until the output result of the last sub-node in a current training node is obtained in the case that the m-th sub-node is not the last sub-node in the current training node, wherein, the output result of the last sub-node in the current training node is the t-th target output result.

13. The method of claim 1, wherein a number T of training iterations corresponding to different training periods is same or different.

14. The method of claim 1, wherein a number N of branches corresponding to different training periods is same or different.

15. A method of model inference, comprising:
determining a target inference task; and
inputting the target inference task to a target model to obtain a target inference result, wherein the target model is obtained by training according to the method of claim 1.

16. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining target sample data corresponding to N branches required in a current training period of distributed training, wherein the target sample data corresponding to the branches includes T different data blocks required for T training iterations; N and T are integers greater than 1;
performing T update operations on network parameters of a preset model deployed on the N training nodes for the distributed training based on the T data blocks corresponding to the branches, to obtain first full parameter sets corresponding to the branches, wherein the first full parameter set represents parameter values of the network parameters in the preset model after T update operations;
performing model parameter fusion on the first full parameter sets corresponding to the branches to obtain a fused full parameter set; and
updating the network parameters of the preset model deployed on the training nodes based on the fused full parameter set, and proceeding to the next training period to obtain a target model.

17. The electronic device of claim 16, wherein a training node comprises M serially connected sub-nodes, and different sub-models of the preset model are deployed on different sub-nodes, so as to perform pipelined model processing by using the M serially connected sub-nodes; M is an integer greater than 1.

18. The electronic device of claim 17, wherein a sub-node comprises a plurality of training units, so as to perform tensor parallel processing by using the plurality of training units included in the sub-node.

19. A non-transitory computer-readable storage medium storing a computer instruction thereon, wherein the computer instruction is used to cause a computer to execute:
obtaining target sample data corresponding to N branches required in a current training period of distributed training, wherein the target sample data corresponding to the branches includes T different data blocks required for T training iterations; N and T are integers greater than 1;
performing T update operations on network parameters of a preset model deployed on the N training nodes for the distributed training based on the T data blocks corresponding to the branches, to obtain first full parameter sets corresponding to the branches, wherein the first full parameter set represents parameter values of the network parameters in the preset model after T update operations;
performing model parameter fusion on the first full parameter sets corresponding to the branches to obtain a fused full parameter set; and
updating the network parameters of the preset model deployed on the training nodes based on the fused full parameter set, and proceeding to the next training period to obtain a target model.

20. The non-transitory computer-readable storage medium of claim 19, wherein a training node comprises M serially connected sub-nodes, and different sub-models of the preset model are deployed on different sub-nodes, so as to perform pipelined model processing by using the M serially connected sub-nodes; M is an integer greater than 1.
